(19) United States
(12) Patent Application Publication
(10) Pub. No.: US 2015/0346119 A1
(43) Pub. Date: Dec. 3, 2015

(54) Determining Perforation Tunnel Impairment Productivity Using Computed Tomography

(71) Applicant: HALLIBURTON ENERGY SERVICES, INC., Houston, TX (US)

(72) Inventor: Dennis J. Haggerty, Burleson, TX (US)

(73) Assignee: Halliburton Energy Services, Inc., Houston, TX (US)

(21) Appl. No.: 14/653,743

(22) PCT Filed: Mar. 26, 2013
(86) PCT No.: PCT/US2013/033849

§ 371 Date: Jun. 18, 2015

(51) Int. Cl. G01N 23/12; G01N 23/04

(52) U.S. Cl. CPC G01N 23/12; G01N 23/046

(57) ABSTRACT

Disclosed is a method of testing the effectiveness of perforations and well treatments to enhance production, wherein tomographic image data is collected while fluid flow tests are conducted on a formation sample and thereafter three dimensional images are created and analyzed.

### CROSS REFERENCE TO RELATED APPLICATIONS

None

### BACKGROUND

1. Technical Field

The invention relates generally to the field of estimating the effectiveness of shaped perforation charges. Included is a method for determining effects on fluid flow of perforating charge on a formation sample. The method includes obtaining or constructing an actual or representative sample (consolidated or unconsolidated material) of the subterranean formation and while subjecting the sample to wellbore pressure conditions using an explosive charge to form a perforation tunnel in the formation sample. Tomographic images of the structure of the perforation tunnel and the damaged or disturbed zones of the crush zone around the perforation tunnel are obtained and analyzed. The perforated sample is then subjected to fluid flow while obtaining tomographic images of the fluid flow in the sample. The tomographic images are used to construct three dimensional images of the sample and flow. At least one aspect of the effects of the perforation on flow is estimated from the tomographic images.

2. Background Art

Hydrocarbon wellbores drilled through subsurface formations typically have a pipe or casing cemented in place after drilling is completed. The casing isolates and protects the various rock formations and provides mechanical integrity to the wellbore. The wellbore is hydraulically connected to a formation from which fluid is to be withdrawn or injected by a process known as “perforating.” Perforating is typically performed by inserting an assembly of explosive shaped charges into the wellbore and detonating the charges. See, for example, U.S. Pat. No. 5,460,095 issued to Slagle et al. The process of shaped charge perforating creates a tunnel or flow conduit that allows reservoir fluids to enter the wellbore and subsequently flow or be pumped out of the wellbore. Or, conversely, the desire is to inject fluids into the reservoir through these same flow conduits created by perforating. However, by creating the perforation tunnels the physical parameters of the formation surrounding the tunnel are often altered in such a manner as to affect flow.

Many factors associated with perforating a well may have an effect on the well productivity. Such factors include gun design including charge type, phasing, shot density, gun type and size; charge performance including penetration, hole size, tunnel geometry, gun standoff and eccentricity; conveyance method; pressure overbalance; gun orientation; and reservoir characteristics including pressure, temperature, permeability, porosity, grain size, compressive strength, unconfined compressive strength, formation fluid type and completion fluid type.

Notwithstanding these numerous parameters, the selection of shaped charge perforators for use in many completions is based solely on API Section I criteria. API Section I tests are designed to provide a simple means to assess charge penetration performance using standard field guns. The tests are conducted in concrete targets perforated under surface conditions after which then the depth of penetration of the perforations is measured.

It is known in the art to test the effectiveness and performance of shaped charges on formation samples. Testing is typically performed by shaped charge manufacturers using a procedure specified by the American Petroleum Institute, Washington, D.C. (“API”) known as Recommended Practice 19B (“RP19B”). In performing RP19B, a formation sample, typically in the shape of a cylinder, is placed proximate the shaped charge undergoing testing. A steel casing segment or plate and a layer of typical casing cement may be disposed between the formation sample and the shaped charge. As used herein, the terms “formation sample” or “target” are used to refer to actual rock or particulate samples of the subject formation or a material chosen to represent the subject formation. A rock formation known as the Berea sandstone is commonly used as a sample or target.

It is also known to test perforation performance in a laboratory under subterranean wellbore pressure conditions. Perforating procedures have been developed to evaluate well perforators under simulated in-situ conditions. For example, API 19B RP Section 4 provides a set of recommended procedures designed to assess performance of perforating gun systems under such conditions. Specifically, the Section 4 test is designed to assess perforation inflow performance for a single shaped charge explosive under simulated in-situ stress and perforating conditions.

During jet perforation and other well treatments, some damage occurs to the rock matrix surrounding the perforation tunnel. The damaged area comprises debris, crushed and compacted rock created by high-impact pressures that occur during perforating and other well processes. Indeed, charge and core debris can be present in an area of the perforation and can completely block flow in that area. This damaged area around the perforation is sometime referred to in the industry as the “crush zone.”

The crush zone surrounding the perforation varies along its depth. For description purposes the crush zone comprises three types of areas. The area of the crush zone closest to and surrounding the perforation is sometime classified as an inner pulverization zone. The pulverization zone is surrounded by a rock matrix fractured zone which in turn is surrounded by a rock matrix compacted sub-zone, The crushed zone consists of crushed and compacted grains forming a crush zone approximately 0.25 to 0.5 in. around the perforation tunnel. It has been found that the damaged area is of non-uniform thickness that varies along the length of the perforation tunnel. It has also been found that the permeability of the crush zone can be further damaged by well treatments and production.

The damaged rock in the crush zone has fluid flow characteristics (permeability) which are inferior to the undisturbed rock matrix. This reduction in permeability in the perforation crush zone reduces the optimum flow into the well from the perforation. While the crush zone damage varies along the length of the perforation there are no methods to accurately measure the local damage or local effect of this damage on permeability.

In testing the effectiveness of the shaped charge, the dimensions of the size and shape of the perforation tunnel made in the target are measured. Conventionally, following flow testing, the target core can be split along its axial axis such that characteristics of the perforation can be determined. For example, the debris-free depth, i.e., the measured distance from rock face to the first debris in the hole, may be measured with a blunt probe. The total core penetration, i.e., the distance from rock face to deepest effect of penetration, may be measured by probing for weakened rock beyond the perforation tip. The perforation diameter profile may be determined by measuring the diameter of the perforation at one inch intervals along the length of the perforation. In another conventional method a cast of the tunnel is made and the surrounding core sample is chipped away and the cast tunnel is measured.

To measure fluid transport properties, the target is subjected to a fluid flow under wellbore conditions and the total flow rate through the target is measured. However, there is no reasonable means for measuring and isolating all fluid transport properties, for example, flow through a particular wall area or portion of the tunnel, flow by direction within the sample, flow through damage to the formation at and around the perforation tunnel. Indeed, current laboratory evaluation methods of fluid transport properties are not only difficult and expensive, but are limited in nature.

It is desirable to be able to estimate or determine a plurality of fluid transport properties of a perforation resulting from a particular shaped charge under dynamic wellbore conditions.

### SUMMARY OF THE INVENTIONS

The present invention disclosed herein provides a method and apparatus for recording fluid transport properties of perforation samples according to API RP 19B Section 4 procedures and creating three dimensional models of the crush zone and flow through the test samples and into the perforation tunnels. According to an aspect of the present invention, a series of tomographic images are made of the perforated sample and of the fluid flow through the sample under well bore conditions. Thereafter, the tomographic data is processed to construct three dimensional images of the perforated sample and of flow performance of a perforation.

According to another aspect of the present invention, the perforation samples are subjected to various formation stimulus treatments and the flow performance changes are evaluated using tomographic images.

### BRIEF DESCRIPTION OF THE DRAWINGS

The drawing is incorporated into and forms a part of the specification to illustrate at least one embodiment and example of the present invention. Together with the written description, the drawing serves to explain the principles of the invention. The drawing is only for the purpose of illustrating at least one preferred example of at least one embodiment of the invention and is not to be construed as limiting the invention to only the illustrated and described example or examples. The various advantages and features of the various embodiments of the present invention will be apparent from a consideration of the drawing in which:

FIG. 1 is a schematic illustration of an apparatus for constructing testing and evaluating perforation tunnel in a formation core to enable testing at simulated wellbore conditions embodying principles of the present invention; and

FIG. 2 is a schematic illustration of flow through a target core to enable fluid flow at simulated wellbore conditions embodying principles of the present invention;

FIG. 3 is graphic view of a perforation illustrating the variance in effective permeability along the length of the perforation; and

FIG. 4 is an illustration of the crush zone surrounding the perforation.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the invention.

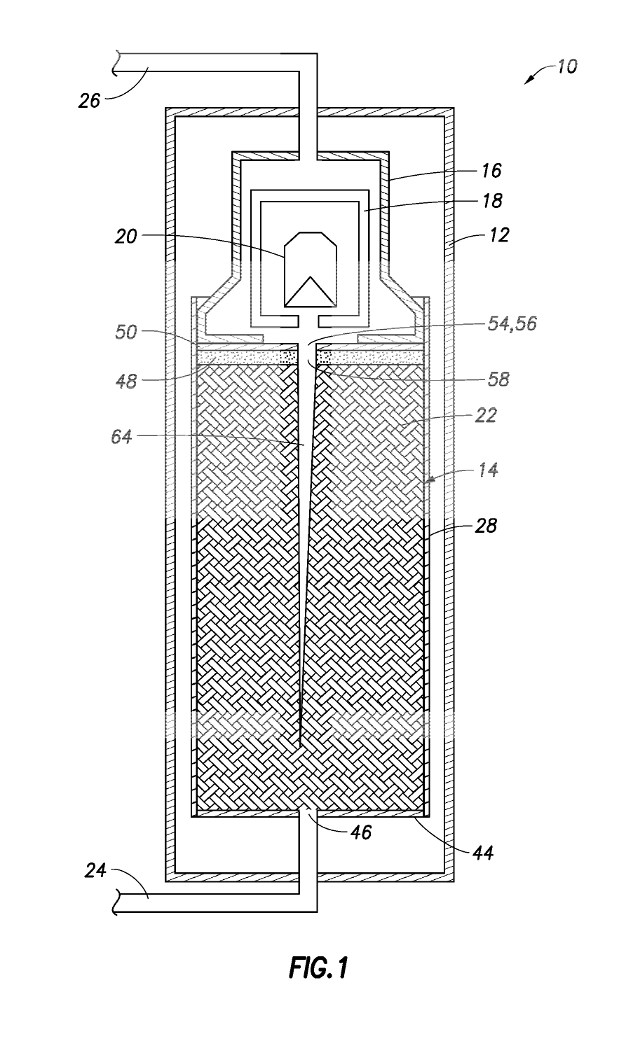

Referring more particularly to the drawings, wherein like reference characters are used throughout the various figures to refer to like or corresponding parts, there is shown in FIG. 1 one embodiment of the testing apparatus 10 for practicing the methods of the present invention. Apparatus 10 includes a pressure vessel 12 that is operable to be pressurized to a desired elevated pressure up to about 12,000 psi to provide a confining pressure on the target assembly 14. This pressure is used to simulate subterranean wellbore conditions. It will be understood by those skilled in the art that other pressures both lower and higher than those specified are also considered to be within the scope of the present invention.

Apparatus 10 includes a simulated wellbore 16 that contains a perforating gun assembly 18 including a shaped charge 20. Simulated wellbore 16 is operable to be pressurized to a desired elevated pressure, however, factors such as whether perforating will take place in an underbalance condition, an overbalance condition, an extreme overbalance condition or the like will determine the desired pressure. Shaped charge 20 may be any desired shaped charge for wellbore use including, for example, a shaped charge taken from a minimum production run of 1,000 RDX, HMX, HNS, PYX or similar explosive containing charges and packaged in the manufacturing company's standard shipping containers.

Apparatus 10 includes a flow system for applying pore pressure to the target core 22. The pore pressure may be any desired pressure, in the illustrated embodiment, only the inlet tubing 24 and outlet tubing 26 of the flow system are depicted. It will be understood by those skilled in the art that a suitable flow system will also include one or more pumps, one or more filters or filter stages, a heating element and the like, as well as, a variety of sensors including flow sensors, pressure sensors, temperature sensors and the like. The fluid that is pumped through the flow system is preferably a mineral spirits but may be any desired fluid or fluids including a brine such as a sodium chloride solution or both oil and brine solution.

Target assembly 14 includes a flexible jacket 28 that may be formed from a rubber or other polymeric or resilient material. Preferably, flexible jacket 28 is substantially cylindrical in shape. Disposed within flexible jacket 28 is target core 22.

A rigid flow distributor plate 44 is preferably formed with flow distributing grooves. As will be explained, plate 44 is preferably made from a material with a relatively low X-Ray attenuation property, such as aluminum. Flow distributor plate 44 provides an interface between target assembly 14 and the flow system such that fluid from the flow system may enter target assembly 14 via opening 46. At its upper end, target assembly 14 includes a cement coupon 48. Those skilled in the art, however, will understand that other materials with various thicknesses may be used such materials and thicknesses may be selected to best match that of the wellbore associated with the reservoir formation being simulated. Also at the upper end of target assembly 14 is a casing plate 50. Casing plate 50 is preferably, a one half inch ASTM 4140 steel or equivalent plate, however, those skilled in the art will understand that other materials with other thicknesses may alternatively be used and would be considered to be within the scope of the present invention such materials and thicknesses may be selected to best match that of the wellbore associated with the reservoir formation being simulated.

The construction of an example target core 22 will now be described. The core 22, for example may be a cylindrical core, formed from a desired formation simulating material, such as Castlegate sandstone.

Once apparatus 10 is in the above configuration, target assembly 14 may be used to run flow tests with target core 22 prior to perforating target core 22. To accommodate flow, a simulated wellbore 52 having an opening 54, is placed adjacent to cement core 48. Target assembly 14 may then be placed in pressure vessel 12 and connected to the flow system such that confining pressure may be applied to target core 22. Confining pressure acts on the exterior of flexible jacket 28. Flexible jacket 28 transmits a radial confining force to support target core 22. In this configuration, flow testing may be performed on target core 22 by pumping a desired fluid through the flow system from inlet tubing 24 to outlet tubing 26.

During the flow testing, a variety of sensors are used to gather data. For example, parameters such as the confined pressure in target core 22, the pressure in simulated wellbore 52, the pore pressure, the fluid temperature in inlet tubing 24, the flow rate through target core 22 and the like will be measured. Based upon these and other measurements that those skilled in the art will take, a determination of factors such as porosity, permeability, pore volume compressibility of target core 22 under various simulated wellbore conditions can be made. These values can be used to calculate the expected flow into a perforation made in target core 22, as described below. In addition to these target core 22 measurements, other flow testing regimens may be performed to determine properties such as relative permeability, capillary pressure, critical velocity, wettability, electrical properties and core-log correlations. In addition, fluid compatibility testing may be performed to determine sensitivity to certain fluids such as completion fluids and treatment fluids including chemicals, gels, resins and injection waters. Further, improved recovery mechanisms may be tested including thermal or steam testing and miscible injections as well as testing with foams or gases.

Independent of or following the flow testing, apparatus 10 may be configured for perforating target core 22. As best seen in FIG. 1, cement coupon 48 is placed on end plate 42. Cement coupon 48 is used to simulate the cement that surrounds the wellbore in the downhole environment. Accordingly, cement coupon 48 is preferably about three quarters of an inch thick. Placed on top of cement coupon 48 is casing plate 50 that is used to simulate the wellbore casing downhole. As such, casing plate 50 is preferably a three-eighths inch thick plate of steel. Next, simulated wellbore 16 is positioned on top of casing plate 50. Disposed within simulated wellbore 16 is gun assembly 18 including shaped charge 20. In this configuration, suitable standoff is established between shaped charge 20 and casing plate 50 to simulate the wellbore environment.

Once apparatus 10 is in this configuration, confining pressure, wellbore pressure and pore pressure may be applied to target core 22. As described above, confining pressure, such as 3,000 psi, is applied by pressurizing pressure vessel 12. This pressure acts on the exterior of flexible jacket 28. Flexible jacket 28 then transmits a radial confining force to target core 22. Wellbore pressure is applied by pressurizing simulated wellbore 16 to a desired pressure. This pressure may be established using fluid within the flow system or via an independent pressure source that may include a fluid accumulator or other pressure ballast that can be precharged. The flow system applies pore pressure to target core 22.

Preferably, the confining pressure, the wellbore pressure and the pore pressure can be brought simultaneously to the desired levels. With the target core 22 at simulated wellbore pressures, the gun assembly 18 may now be used to detonate shaped charge 20 to form a perforation in target core 22. As is known in the industry, upon detonation, a jet formed from shaped charge 20 penetrates into target core 22 forming opening 56 in casing plate 50, opening 58 in cement coupon 48, and perforation 64 in target core 22.

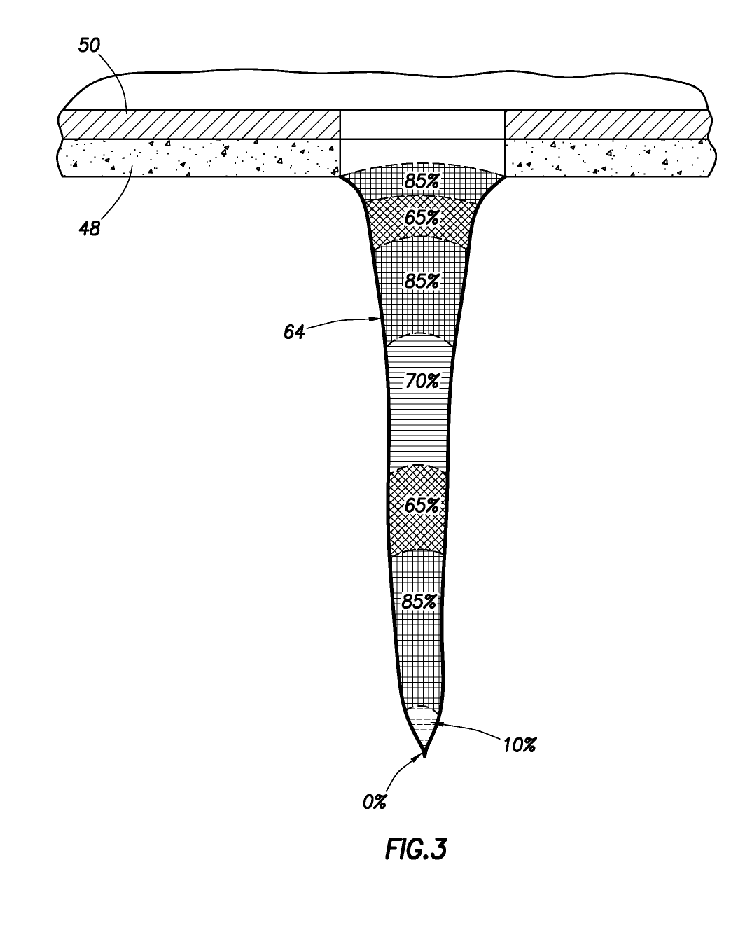

As previously mentioned, the jet perforation process will cause the permeability of the material surrounding the perforation to vary. FIG. 3 illustrates the permeability variance along the length of the perforation 64 as caused by the damage in the crush zone. The percentages listed are a measure of the permeability in the perforation area compared to the permeability of clean formation rock. In the illustrated example the permeability zones vary form 0% in the debris area to 85% in other areas. Even thought for ease of illustration the zones are shown as being discrete they would not be in the actual sample. The listed percentages were randomly selected to illustrate the variance principal and were not derived from any test data.

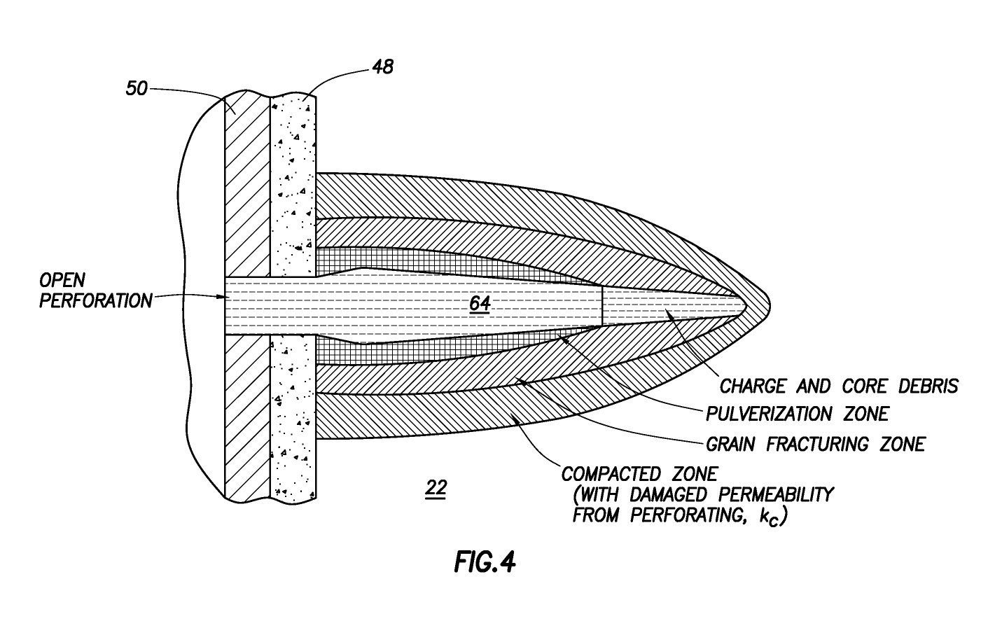

FIG. 4 is a diagram illustrating theoretical crush zone surrounding the perforation 64. Typically, the inside zone comprises pulverized formation rock and is tightly packed. The next zone would have grain fracturing in the formation rock. The outer zone would be compacted to some degree. FIG. 4 is a hypothetical illustration included for the purpose of illustrating the principle that the zones vary in thickness along the length of the perforation.

Once perforation 64 has been formed, the pore pressure is maintained or adjusted to initiate flow through target core 22. Once flow is established, a volume of fluid can be flowed through target core 22 at this pressure. Preferably, fluid is allowed to flow through target core 22 until no further change in flow rate occurs. Thereafter, any number and type of flow tests, such as those discussed above, may be performed. Calculate the Production Ration (PR) according to the API RP 19B Section 4 tests. Additional conventional flow tests can be performed on the core 22 to simulate perforations which have been subjected to well treatments and production. It is pointed out that no conventional method exists to measure the variations in flow through the crush zone surrounding the perforation.

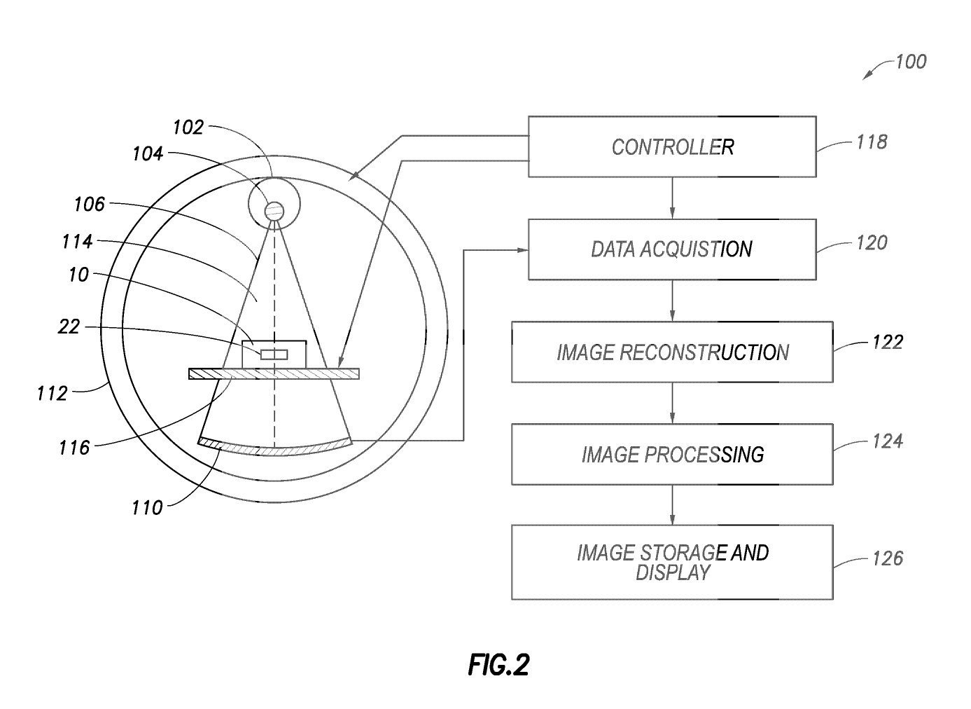

Turning now to FIG. 2 there is illustrated a schematic of a conventional multi-slice CT scanner 100 set up to generate tomographic images of the perforation in target core 22 and for generating images of fluid flow in the core. According to the present inventions the apparatus 10 holding the target core 22 is made from a material and a thickness that does not substantially attenuate X-Rays. Materials with reduced attenuation are well known in the industry. Examples of materials with relatively low attenuation properties suitable for making pressure vessels include carbon-fiber or aluminum. In particular the pressure vessel 12 and jacket 28 are made from materials that do not substantially attenuate X-Rays. The combination of the core holder, size and material, and the strength of the X-ray source, as in ample Key need to allow for the required resolution.

X-Ray source 102 comprises a focal spot 104 from which X-Ray beam 106 is emitted. The X-Ray beams are attenuated by apparatus 10 and impinge on detector array 110. X-Ray source 102 and detector array 110 are mounted on a rotating frame 112 and made to rotate about rotation axis 114 (along the Z direction) while acquiring attenuation data from multiple view angles. Apparatus 10 position, source rotations and other functions of system 100 are controlled by control unit 118. Attenuation data acquired by data acquisition sub-system 120 is reconstructed to three dimensional (3D) images by image reconstruction sub-system 122, wherein the images are optionally processed further by image processing sub-system 124 and optionally stored and/or displayed by image storage and display sub-system 126.

Preferably, system 100 is a multi-slice scanner which during irradiation and data acquisition multiple sets of attenuation data are acquired by the multiple detectors. The attenuation data from multiple view angles are reconstructed to multiple slice or volumetric images using algorithms known in the art. Common algorithms for image reconstruction of fan beam or cone beam CT scanners include preprocessing the raw detector data, convolution of the data along rows of detector elements with filter function and back-projection of the filtered data to images. However other algorithms may be used as well. Preferably, the entire core 22 is contained in the scan field as defined by the X-ray beam and detector coverage.

With the apparatus 10 arranged in the CT Scanner 100 and the target core 22 located in the X-Ray beams 106, the above described testing can be conducted and three dimensional images created of the perforation tunnel 64, its crush zone and flow through various portions of the core 22 and crush zone.

For example, wellbore pressure conditions can be simulated in the apparatus 10. A first fluid (example mineral oil) of known density can be injected through opening 46 and into the end face of the core sample 22. Fluid flow is continued until a steady flow rate is achieved at a set pressure differential as described above. Next, collect image data by conducting multiple high resolution CT scans of the core 22 while flowing fluid at the steady state through the core. Next, reconstruct and process the image data to generate a three dimensional image of the walls of the perforation tunnel 64.

Next, begin flow of a marker fluid or contrast agent through the core 22 from opening 46. As used herein, “marker fluid” refers to a substance used to enhance the contrast of structures or fluids within a core sample. The marker fluid contains materials that attenuate X-Rays, such as, doped oil with 6% iodine or barium solution. Run a series of scans as the marker fluid progresses through the core 22 and into the perforation tunnel.

In one embodiment, flow of the interface of the marker fluid through the core and perforation crush zone is advanced in discrete steps. After each step a scan is run. For example, a small amount of fluid (for example 1 ounce) could be removed through 26 between each tomographic scan of the core. For reference purposes this process is designated as “stop frame scanning.” The images from the stop frame scanning can be electronically merged to create a three dimensional movie of the flow into and though the core.

Next, reconstruct and process the image data from the stop frame scanning to generate a three dimensional image of the flow of the marker fluid through the core. This process will result in a series of images of the progress of the flow into the and across the sample core and ultimately into and out of the perforation tunnel crush zone and interior. The marker fluid creates a recordable contrast representing the instantaneous interface between the marker fluid and the existing fluid in the sample.

Flow of the marker fluid could be continued until flow rate stabilizes at a given pressure. Then, change the pressure to change the flow rate and conduct new CT scans of the core.

Process the image data to calculate the percent of tunnel wall surface contributing to flow and compare to the Production Ration (PR) calculated in the Section 4 test.

In another example, additional tests are conducted, including reverting back to the first fluid and scan to locate rock-fluid absorption or wetting or non-wetting phase retention.

In a further example, the fluid flow is changed to a gas such as, nitrogen and CT scans are run. The data is reconstructed and processed to determine where the fluid is entering the perforation tunnel and where flow is stagnant. In this manner formation crush zone can be quantified.

In an even further example, CT scans of one or more of the flow tests described above are conducted. Thereafter, the core is subjected to a stimulation treatment, such as Hydrochloric or Formic acid after the perforation tunnel is formed. CT scans of one or more of the flow tests described above are conducted after the stimulation treatment. The images are reconstructed and processed to determine the effectiveness of the stimulation treatment by comparing images before and after treatment.

While compositions and methods are described in terms of “comprising,” “containing,” or “including” various components or steps, the compositions and methods also can “consist essentially of” or “consist of” the various components and steps. As used herein, the words “comprise,” “have,” “include,” and all grammatical variations thereof are each intended to have an open, non-limiting meaning that does not exclude additional elements or steps.

Therefore, the present inventions are well adapted to carry out the objects and attain the ends and advantages mentioned, as well as, those which are inherent therein. While the invention has been depicted, described, and is defined by reference to exemplary embodiments of the inventions, such a reference does not imply a limitation on the inventions, and no such limitation is to be inferred. The inventions are capable of considerable modification, alteration, and equivalents in form and function, as will occur to those ordinarily skilled in the pertinent arts and having the benefit of this disclosure. The depicted and described embodiments of the inventions are exemplary only, and are not exhaustive of the scope of the inventions. Consequently, the inventions are intended to be limited only by the spirit and scope of the appended claims, giving full cognizance to equivalents in all respects.

Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A method for determining effects of perforation on a subterranean formation sample, comprising:
selecting a formation sample;
creating a perforation tunnel in the formation sample;
flowing fluid into the formation sample; and
thereafter conducting tomographic scans of flow in the formation sample while fluid is flowing in the sample.

2. The method of claim 1, additionally comprising making a series of tomographic images of the progression of flow through the formation sample.

3. The method of claim 1, wherein the flowing fluid step comprises flowing a marker fluid into the formation sample.

4. The method of claim 3, wherein the fluid flowing step comprises flowing fluid containing iodine.

5. The method of claim 3, wherein the fluid flowing step comprises flowing fluid containing barium.

6. The method of claim 1, wherein the flowing fluid step comprises flowing fluid in the gaseous state.

7. The method of claim 6, wherein the gas comprises nitrogen gas.

8. The method of claim 1, additionally comprising the steps of:
discontinuing flow through the formation sample after conducting tomographic scans;
flowing stimulation treatment fluid through the perforation tunnel and into the formation sample; and
flowing fluid into the formation sample;
conducting tomographic scans of flow in the formation sample while fluid is flowing in the sample; and
comparing the data from the tomographic scans before formation treatment and after formation treatment.

9. The method of claim 1, additionally comprising collecting data from the tomographic scans and processing the data to form images of the fluid flow.

10. The method of claim 2, additionally comprising collecting data from the tomographic scans and processing the data to form images of the fluid flow.

11. The method of claim 1, wherein the formation sample comprises solid material.

12. The method of claim 1, wherein the formation sample comprises granular material.

13. The method of claim 1, additionally comprising the step of discontinuing flow into the formation sample, then injecting treatment fluid into the perforation tunnel and formation sample; next conducting tomographic scans; and thereafter conducting additional tomographic scans of flow in the treated formation sample.

14. The method of claim 1, additionally comprising the steps of:
discontinuing flow through the formation sample after conducting tomographic scans;
flowing stimulation treatment fluid through the perforation tunnel and into the formation sample;
flowing fluid into the formation sample;
conducting tomographic scans of flow in the formation sample while fluid is flowing in the sample; and
comparing the data from the tomographic scans before formation treatment and after formation treatment.

15. The method of claim 1, wherein the perforation tunnel formation is conducted while the formation sample is subjected to an elevated pressure.

16. The method of claim 2, wherein the perforation tunnel formation is conducted while the formation sample is subjected to an elevated pressure.

17. The method of claim 1, wherein the perforation tunnel formation, fluid flowing and tomographic scans are conducted while the formation sample is subjected to an elevated pressure.

18. The method of claim 1, wherein the perforation tunnel formation, fluid flow in the formation sample, and tomographic scanning is conducted while the formation sample is located inside a pressure vessel that made from material that does not substantially attenuate X-Rays.

19. The method of claim 18, wherein the pressure vessel material comprises aluminum.

20. The method of claim 18, wherein the pressure vessel material comprises carbon fiber.

21. A method for determining effects of perforation on a subterranean formation sample, under elevated pressure conditions, comprising:
maintaining the sample at elevated pressure conditions corresponding to a subterranean pressure; and while maintaining the sample at the elevated pressure:
(a) creating a perforation tunnel in the formation sample by using an explosive charge;
(b) flowing fluid into the formation sample and out of the perforation tunnel;
(c) conducting tomographic scans and collecting image data as the fluid flow progresses through the sample and into the perforation tunnel; and
thereafter, processing the image data to create images of the flow in the sample.

22. The method of claim 21, wherein the perforation tunnel creating step comprises damaging the sample around the perforation to form a crush zone and wherein the tomographic scan steps comprise conducting tomographic scans to collect data relating to the fluid flow through the crush zone of the sample.

23. The method of claim 21, additionally comprising flowing a marker fluid into the sample and wherein the tomographic scan steps comprise utilizing a stop frame scanning process to record the flow of the marker fluid.

24. The method of claim 23, additionally comprising processing the data to create a three dimensional movie of the progression of marker fluid flow into the sample.

25. A method for determining effects of perforation on a subterranean formation sample, under elevated pressure conditions, comprising:
subjecting the sample to an elevated pressure while creating a perforation tunnel in the formation sample; and
using tomographic scans to make a three dimensional image of the walls of the perforation tunnel in the formation sample.

26. The method of claim 25, wherein the perforation tunnel creating step comprises damaging the sample around the perforation and creating a crush zone in the sample and wherein the tomographic scan steps comprise conducting tomographic scans to collect data relating to the fluid flow through the crush zone in the sample.

27. The method of claim 25, additionally comprising the step of flowing fluid through the sample while conducting tomographic scans to collect data relating to the crush zone.

28. The method of claim 25, additionally comprising flowing a marker fluid into the sample and wherein the tomographic scan step comprises utilizing a stop frame scanning process to record the flow of the marker fluid.

29. The method of claim 28, additionally comprising processing the data to create a three dimensional movie of the progression of marker fluid flow into the sample.
